(19) United States
(12) Patent Application Publication
(10) Pub. No.: US 2024/0216729 A1
(43) Pub. Date: Jul. 4, 2024

(54) Water Bomb: A system and process to extinguish the fire in larger areas

(71) Applicant: Mubariz Abdullayev, Baku (AZ)

(72) Inventor: Mubariz Abdullayev, Baku (AZ)

(21) Appl. No.: 18/089,626

(22) Filed: Dec. 28, 2022

(51) Int. Cl. A62C 3/02

(52) U.S. Cl. CPC A62C 3/025

(57) ABSTRACT

The current invention proposes a Water bomb and fins made from bio polyethylene (bio-PVC) and designed to extinguish fires in hard-to-reach areas, for instance, forests and mountains. The water bombs are dropped from any cargo aircraft and from a height of at least 2 km (for arducam fire detection bomb) and 1 km (passive bomb option). The Water Bomb hits the inferno of the fire as a result of a free fall aided by four panning fins. The bomb consists of three parts—the nose with an arducam fire detection camera, the central section, and the rear section where the four fins, water inlet connector, and mini avionics board with Arduino nano guidance kit are located. The water capacity of the Water Bomb varies from a minimum version of 1400 liters (370 gallons) to a maximum of 2500 liters (600 gallons).

### BACKGROUND

### Copyright Notice

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### FIELD OF THE INVENTION

This invention relates to fire extinguishers, more specifically to the means of extinguishing wildfires and fires in hard-to-reach places using water bombs.

### DESCRIPTION OF THE RELATED ART

The forest reserves are not only one of the ecosystem maximum on the earth, but also are important ecological protective screens that social economy realizes sustainable development. Forest fire often causes the national economy to be subject to heavy losses as a kind of disaster comparatively serious in a natural disaster.

A forest fire can burn a very large area of forest in a very short time and threaten residential and commercial areas near the forest. A large forest fire will likely result in large fire-fighting costs and other economic losses and endanger wildlife and humans. Four elements are needed to start and sustain a fire: (1) fuel, (2) heat or other ignition sources, (3) oxygen, and (4) chemical reaction. Various methods of fighting forest fires are known in the art.

One common method of fighting a fire is to spray water on the fire with a hose fed by a water main, a water tanker, a lake, or a stream to cool the fire, thus removing the element of heat. The water may also dilute the oxygen in the air around the fire when the water is converted into water vapor. A helicopter or an airplane may be used to drop large amounts of water on the fire. Another method of fighting forest fires is to remove the fuel by removing undergrowth and trees in the fire's path or by back-burning an area in front of the fire. A liquid, foam, or solid chemical flame retardant may be sprayed or dropped on a fire to interrupt the chemical chain reaction. The chemical may react with the fuel to stop combustion or it may form a blanket that separates the oxygen in the air from the fuel.

By looking at prior art multiple types of inventions have been proposed regarding fire extinguishing systems under complex and difficult situations. For instance, a CN patent 2,028,59955U issued to Chinese inventor discusses a remote early warning and fire extinguishing system for forest fire. The utility model relates to a remote early warning and fire extinguishing system for forest fire and aims to solve the problems in the process from unmanned aerial vehicle fire source recognition to accurate throwing of high-explosive fire-extinguishing packets, so that the operation of early discovering and extinguishing the forest fire is realized. The fire extinguishing system comprises an unmanned aerial vehicle and a remote flight control platform, wherein the unmanned aerial vehicle part comprises an aircraft, a driverscope, an early warning and accurate throwing control load and a high-explosive fire-extinguishing packet; and the remote flight control platform comprises a path planning module and a data storage module. According to the system, the fire source in a large-scale forest can be timely discovered, the high-explosive fire-extinguishing packets can be accurately thrown after the fire source is discovered, and the function of extinguishing or controlling the fire is realized; and moreover, the system can be repeatedly used, and the overall construction cost of the unmanned aerial vehicle remote early warning and fire extinguishing is reduced.

Another patent on a system for extinguishing and suppressing fire in an enclosed space in an aircraft bearing U.S. Pat. No. 6,676,081B2 is issued to Airbus Operations GmbH. The invention discusses a system for extinguishing and suppressing a fire in an enclosed space includes a Halon storage container and a nitrogen generator that are both connected by a duct system to extinguishing nozzles arranged in the enclosed space. Halon is supplied as a first extinguishing agent from the container to achieve a rapid initial extinguishing of the fire. Nitrogen enriched air is supplied as a second extinguishing agent from the nitrogen generator to achieve a continuous long-term fire suppression, commencing simultaneously with or after the introduction of the Halon. The nitrogen generator may include a molecular sieve to continuously generate the nitrogen enriched air from an inlet flow of environmental air.

Another CN patent 1,076,70201A on UAV system type fire extinguishing system is issued to Chinese inventor. The invention provides a kind of UAV system type fire extinguishing system, and it includes being loaded with the unmanned plane of fire extinguishing component, commander's transport vehicle, remote control center, wherein: The unmanned plane of fire extinguishing component is loaded with, it is the unmanned carrier aircraft group of planes for being mounted with airborne version fire extinguisher bomb, and it can deliver fire extinguisher bomb and transport to appointed place, as outside high-rise window, is launched it after adjusting posture run-home, is then returned to repetition delivery; Transport vehicle is commanded, connects a unmanned carrier aircraft and remote control center with trunking thereon, while the carrier aircraft constantly to return supplements fire extinguisher bomb etc. The present invention can pass through the unmanned carrier aircraft of remote control, round-the-clock, closely monitoring and the precision strike that transmitting airborne version fire extinguisher bomb is realized the fixed point to burning things which may cause a fire disaster, positioned in good time in all directions can be carried out to the burning things which may cause a fire disaster in special area place, thus can be with the extremely flexible fire suppression operation suitable for all kinds of misfortunes danger in the case of heavy.

A RU patent 2,744,324C1 on Fire extinguishing system and method is issued to Russian inventor. The invention relates to the detection and prevention of emergencies and the elimination of their consequences and namely to fire extinguishing. The developed fire extinguishing system has a fire extinguishing control module, a reconnaissance aircraft (AC), at least one carrier aircraft and a lot of unmanned combat air vehicles (UCAVs). The fire extinguishing control module is designed with the possibility of two-way continuous interaction with the reconnaissance aircraft and the carrier aircraft, the formation and adjustment of the fire extinguishing algorithm depending on the constantly incoming information from the reconnaissance aircraft and the carrier aircraft, the transfer of the fire extinguishing algorithm to the carrier aircrafts and the configuration of the location of the carrier aircraft and the group of UCAVs when extinguishing a fire. The reconnaissance aircraft is capable of bilateral continuous interaction with the fire extinguishing control module, detecting the fire source, determining the type of fire source, its coordinates and parameters, the direction and speed of fire movement, the strength and direction of the wind, data transmission to the fire fighting control module. The carrier aircraft is designed with the possibility of two-way continuous interaction with the fire extinguishing control module and with the UCAV, delivery of the UCAV to the fire site and their release, the formation of a group of the UCAVs of a certain spatial configuration depending on the type of fire. UCAVs are designed to hit the target point of the fire and release a charge of an extinguishing agent with complete self-destruction. They have an aerodynamic body with an electric motor, a control system and a charge in the form of solid carbon dioxide. Also disclosed is a method of extinguishing a fire using the specified system. EFFECT: ensuring high accuracy of hitting charges, increasing the efficiency of fire extinguishing as well as ensuring the mobility of the system.

Another US patent 2,011,0315408A1 on Fire Extinguishing System for an Airplane and Method for Fire Fighting in an Airplane is issued to Airbus Operations GmbH. The patent discusses an airplane fire extinguishing system comprises an extinguishing agent storage unit with an activatable closing device, which makes possible, when active, an outflow of extinguishing agent from the extinguishing agent storage unit, and a supply line, connected with the closing device and an outlet opening, via which the extinguishing agent can be conducted from the extinguishing agent storage unit to the outlet opening, in order to eject it there for firefighting, wherein one or more sensor systems are present, by means of which a current airplane state can be determined, and a control unit, connected with the closing device and an actuatable input element, is present, via which the closing device can be activated, the control unit constructed and configured in such a way that the closing device is activated, as a function of the current airplane state, which exists at the time of an actuation of the input element.

There are multiple inventions that have been proposed in prior art regarding bringing advancement and enhanced utility in extinguishing fires at a larger scale. However, regarding the utilization of these systems as far as forest fires are concerned, very few advancements have been seen. Presently available solutions including but not limited to firefighting aircraft are very expensive, and there are only a few aircraft manufacturers in the world that can offer a range of similar aircraft. Sometimes the queue for the purchase of such equipment stretches for years.

The instant invention attempts to overcome deficiencies of the prior art and solutions by providing a waterbomb which is a large cigar-shaped canister that can hold up to 2,000 liters of water. These empty bombs are filled with water and thrown from the height of the affected area. The studies have gathered positive outcomes from the proposed solution and will be discussed in detail in later sections.

None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to advancement in offering an advanced approach toward extinguishing the fire at a larger scale, especially in forest areas.

It is further the objective of the invention to provide a safe, easy-to-use, and low-cost solution for extinguishing the fire at the forest.

It is moreover the objective of the invention to provide empty canisters which are loaded into a cargo aircraft and are filled with water thus providing ease of use in fire extinguishing operations.

It is another object of the present invention to provide a new and improved approach that provides greater output and benefits as compared to traditional methods.

It is a further object of the present invention to provide a new and improved method that is of durable and reliable construction.

An even further object of the present invention is to provide a new and improved method that is susceptible of a low cost of manufacture with regard to both materials and labor, and which accordingly is then susceptible of low prices of sale to the consuming public, thereby making such procedure economically available to the buying public.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of the invention, illustrating the Water Bomb with spread fins.

FIG. 2 is an exploded respective view of the invention, illustrating a Water Bomb including a water tank section with an arducam fire the detection camera at the top of the nose cone, four fins with panning Actuators, and a shaft with rotary spring locking mechanism. The rear section includes a Storz-type water inlet female connector, an automatic water pressure spring faucet, and a guidance electronic section.

FIG. 3 is a perspective view of the invention, illustrating the assembled Water Bomb for loading into the aircraft cargo hold.

FIG. 4 is a perspective view of the invention, illustrating the whole back end consisting of four fins with panning actuators and a shaft with a rotary spring locking mechanism. The rear section includes a Storz-type water inlet female connector, an automatic water pressure spring faucet, and an onboard electronic section.

FIG. 5 is a transparent perspective view of the invention, illustrating a Storz-type water inlet female connector with an automatic water pressure spring faucet, and the hexagon shape of the guidance electronic section.

FIG. 6 is a transparent perspective view of the invention, illustrating a fin with one panning actuator and a shaft with one rotary spring locking mechanism.

FIG. 7 is another transparent perspective view of the invention, illustrating a fin with one panning actuator and shaft with one rotary spring locking mechanism and single loop bushing groove of the other parts of the shaft.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

There is only one known way to effectively extinguish wildfires, which is aerial firefighting. It's all about dropping water from the air by an expensively specialized aircraft with a capacity of up to 15,000 liters (4 000 gallons). Evidently, these airplanes are incredibly expensive and due to the increased number of world wildfires, there is a long line to purchase them. Moreover, a pilot does not always strike the core in a water drop on the first tray. After all, there are cases of crashes of firefighting planes due to the difficulties of approaching the line of fire at a low altitude since part of the water dropped from a greater height often evaporates. The success of the mission will always depend on the presence of a lake/sea near the wildfire area where the firefighting plane could replenish the water tank in flight.

The current invention of the Water Bomb aims to simplify the task of wildfire fighting and opens the possibility of greatly expanding the range of countries and government firefighting agencies that own quite reliable and available means to combat raging forest fires in an effective way.

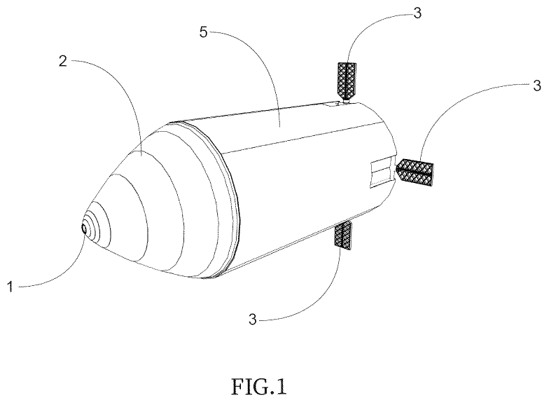

Now to explain further we can refer to the attached drawings. Referring to FIG. 1 illustrated is the bio-PVC-made Water bomb formed of the nose cone 2 with arducam fire detection camera 1 at the top of the cone, hull 5, and spread guidance fins 3.

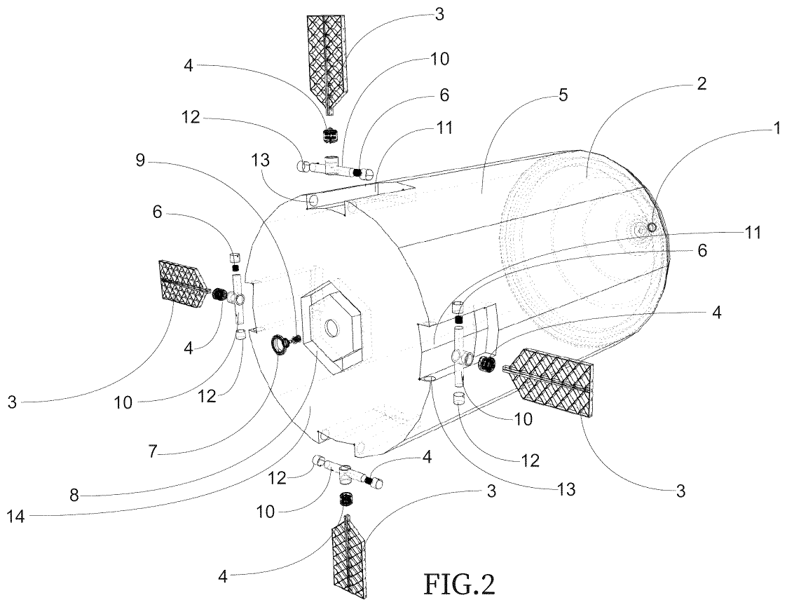

Referring to FIG. 2 the invention is illustrated in exploded view. The bio-PVC fins 3 located in the hull section 11 consists of fixed-to-it panning actuator 4 which is fastened to the aluminum shaft 10 and inserted to the holes 13 with 90-degree position locking coupling 12 on the one side of the shaft 10 and spring coupling 6 on the other end of the shaft 10. The back-end side 14 hosts Storz-type female aluminum inlet connector 7 with water pressure spring faucet 9 which opens the valve to fill water at a pressure of at least 7 psi.

The entire mini avionics system and power supply battery are located in a rhomboid shape section 8.

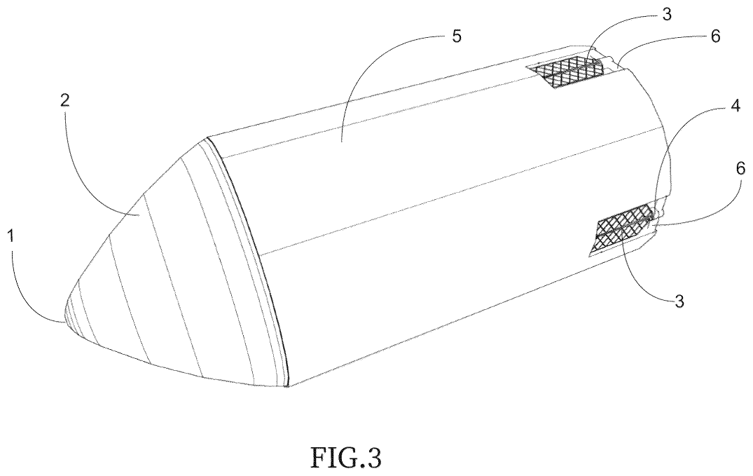

Referring to FIG. 3 illustrates another perspective view of the water bomb described in FIG. 1 having nose cone 2 with arducam fire detection camera 1 at the top of the cone, hull 5, spread guidance fins 3, and spring coupling 6.

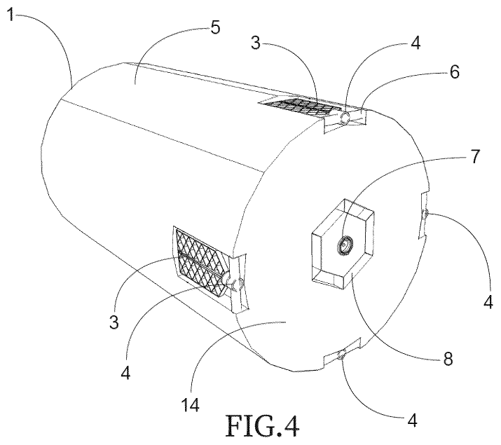

Referring to FIG. 4 illustrates a rear perspective view from the back-end side 14 with folded fins 3, Storz-type water inlet connector 7 and mini avionics section 8.

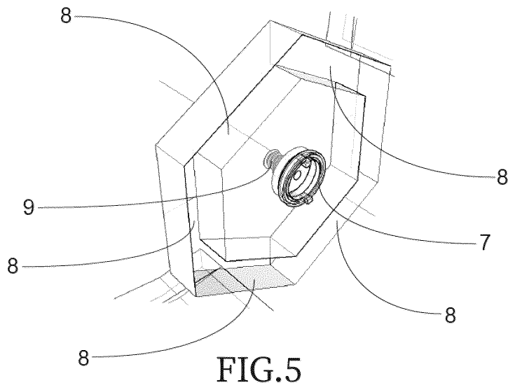

Referring to FIG. 5 the Storz-type aluminum female inlet connector 7 with built-in automatic water pressure spring faucet 9 which is set to 7 psi unlock pressure. All the onboard electronics including arduino nano board and mini avionics are located in a diamond (rhomboid) shape section 8.

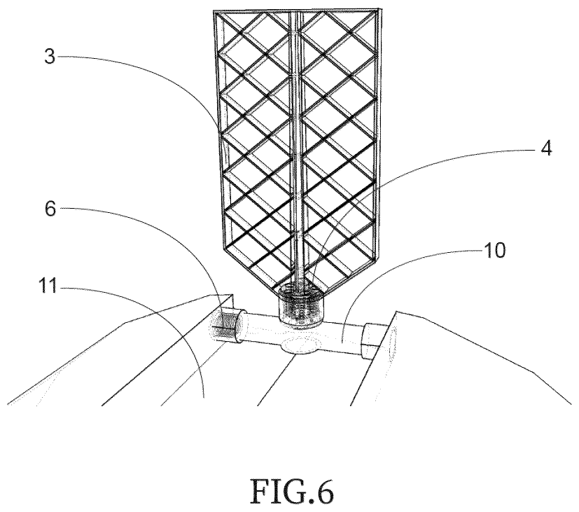

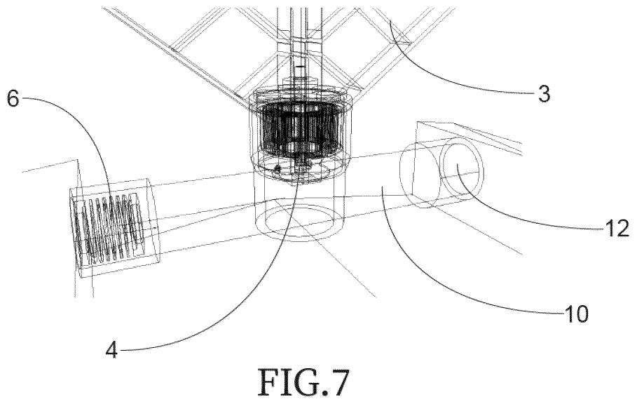

Referring to FIG. 6 and FIG. 7 illustrated is the bio-PVC made guidance fin 3 which panning around its axis by means of fixed actuator 4 attached to the main horizontal (tilt) movement aluminum shaft 10 attached to the hull 5 in FIG. 1 into the holes 13 in FIG. 2.

The tilt movement shaft 10 opens once by means of a spring 6 and fixes its horizontal position by means of automatic coupling 12.

As per its further embodiments, the Waterbomb and fins are made from bio polyethylene (bio-PVC). All metallic parts are made from aluminum. Known as green metal, aluminum is one of the most environmentally friendly metals because of its sustainability.

As per its additional embodiments, the length of the bomb can be from 2 to 3 meters, with a diameter of 100 cm, so the maximum capacity varies from 1400 liters (370 gallons) to 2500 liters (600 gallons). Such dimensions provide the most convenient size for loading into the cargo hold of most aircraft in the world. For example, Hercules C-130 can carry up to 12 pcs of 2-meter bombs, which is 17,000 liters of water (5,000 gallons).

The assembly as per its further embodiments is designed to extinguish fires in hard-to-reach areas (forests, mountains) and it is dropped from any cargo aircraft from a height of at least 2 km (actively guided bomb) and 1 km (passive bomb option), the Waterbomb hits the inferno of the fire as a result of the arducam fire detection camera and fins-guided free fall, does not carry any additional propulsion devices or propeller motors. The Waterbomb has a Storz-type fire extinguishing standard inlet connector, which allows quickly filling empty water bombs with water in a short time.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A structure to extinguish a forest fire comprising:
a Bio-PVC made a cylindrical structure formed of the nose cone 2 with arducam fire detection camera 1 at the top of the cone, hull 5, and spread guidance fins 3;
a bio-PVC fins 3 located in the hull section 11 consists of fixed-to-it panning actuator 4 which is fastened to the aluminum shaft 10 and inserted to the holes 13 with 90-degree position locking coupling 12 on the one side of the shaft 10 and spring coupling 6 on the other end of the shaft 10;
a back-end side 14 hosting Storz-type female aluminum inlet connector 7 with water pressure spring faucet 9 which opens the valve to fill water at a pressure of at least 7 psi;
a mini avionics system and power supply battery are located in a rhomboid shape section 8.

2. The water bomb as per claim 1, includes back-end side 15 with folded fins 3 Storz-type water inlet connector 7, and mini avionics section 8.

3. The water bomb as per claim 1, includes Storz-type aluminum female inlet connector 7 with built-in automatic water pressure spring faucet 9 which is set to 7 psi unlock pressure.

4. The water bomb as per claim 1, includes electronics that are arduino nano board and mini avionics are located in a diamond (rhomboid) shape section 8.

5. The water bomb as per claim 1, includes bio-PVC-made guidance fin 3 which pans around its axis by means of fixed actuator 4 attached to the main horizontal (tilt) movement aluminum shaft 10 attached to the hull 5.

6. The water bomb as per claim 1, includes the tilt movement shaft 10 opens once by means of a spring 6 and fixes its horizontal position by means of automatic coupling 12.
